(19) United States
(12) Patent Application Publication
(10) Pub. No.: US 2007/0275178 A1
(43) Pub. Date: Nov. 29, 2007

(54) Substrate Heating Apparatus and Substrate Heating Method

(76) Inventors: Takanori Nishi, Koshi-shi (JP); Takahiro Kitano, Koshi-shi (JP); Katsuya Okumura, Tokyo (JP)

Correspondence Address: SMITH, GAMBRELL & RUSSELL, 1850 M STREET, N.W., SUITE 800, WASHINGTON, DC, 20036, US

(21) Appl. No.: 11/630,440

(22) PCT Filed: Jul. 13, 2005
(86) PCT No.: PCT/JP05/12956

§ 371 Date: Dec. 22, 2006

(30) Foreign Application Priority Data
Jul. 15, 2004 (JP) 2004-208508

(51) Int. Cl. B05D 1/18; B05B 5/00

(52) U.S. Cl. 427/430.1; 118/641

(57) ABSTRACT

A substrate heating apparatus for heating a substrate coated with a film of chemically amplified resist within a period after exposure and before development, having a mounting table to mount the substrate substantially horizontal with the resist-coated film faced up, a fluid supply mechanism for supplying glycerin to the substrate, and a heating mechanism for heating the substrate on a mounting table, in a state that glycerin contacts a resist-coated film, wherein the substrate on a mounting table is heated, in a state that glycerin contacts the resist-coated film.

### TECHNICAL FIELD

The present invention relates to a substrate heating apparatus and method for coating a substrate with a chemically amplified resist, and baking the resist-coated film after exposure and before development (Post Exposure Bake; PEB).

### BACKGROUND ART

A photolithography process of semiconductor device uses a system incorporating a coating-developing apparatus in an exposure apparatus. As a line width of a circuit pattern reaches a deep submicron range, a chemically amplified resist is mainly used in a coating-developing apparatus. A chemically amplified resist contains an acid-generating agent to generate acid when heated. When a heating process called PEB (Post Exposure Bake) is performed, the acid diffuses in an exposure area and acid catalysis occurs.

FIG. 1A-FIG. 1C are schematic illustrations showing exposing, heating and developing processes by using a positive chemically amplified resist. First, perform pattern exposure for a wafer W coated with a resist R film through a mask M. A proton (H⁺) is generated as acid in an exposure area, as shown in FIG. 1A. Then, heat the wafer W to a temperature of 90-140° C. in the PEB process, the proton (H⁺) diffuses in the resist R, and accelerates acid catalysis. Thus, as shown in FIG. 1B, the proton (H⁺) resolves a base resin of the resist R, and the resist R becomes soluble in a developing solution. During the acid catalysis, a new proton (H⁺) (or a component equivalent to acid) is generated like a chain reaction, and the new proton (H⁺) resolves the base resin. In this way the acid catalysis is amplified and accelerated one after another. Then, pour a developing solution on the resist R coated film. An exposed portion is dissolved, and a resist pattern is formed, as shown in FIG. 1C.

As described above, a chemically amplified resist is in principle applicable to precise line width. However, acceleration of chemically amplified resist is determined by the amount of acid catalysis, and the heating condition after exposure has a large influence upon the characteristics of a chemically amplified resist, particularly, the accuracy of the line width of a pattern obtained after development.

Jpn. Pat. Appln. KOKAI Publication No. 2001-274052 describes a conventional heating apparatus. As shown in FIG. 2, place a wafer W on a heating plate 1 having a heater 10 buried inside, put on a cover unit 11 to make a processing space, and make a current of purge gas from the outside of the processing space to the center of the space, and heat the wafer W by the heater 10 (refer to the paragraphs 0005-0006 of the Publication).

A pattern has become more and more precise, and recently, a production system has been shifted from mass production of one type of product to production of small batches of more different products. Therefore, production of an exclusive mask for each type of product increases a unit price of a product. In the circumstances, Jpn. Pat. Appln. KOKAI Publication No. 2002-50567 examines and reports a mask-less writing technique called a character projection by using an electron beam (hereinafter, called an electron beam writing exposure).

Electron beam writing exposure will be briefly explained with reference to FIG. 3. A reference numeral 2 denotes an electron gun for emitting an electron beam. An electron beam emitted from the electron gun 2 is bent by an electrostatic field formed by a first deflecting means 21, and passed trough an opening of predetermined combination of various round, triangular and square openings (not shown) formed on each surface of upper and lower aperture stops 22a, 22b, . . . , whereby a cross section of an electron beam is shaped as a predetermined pattern. Then, an electron beam is bent again by a second deflecting means 23, and applied to a predetermined area on the surface of a wafer W. Therefore, electron beam writing exposure has the advantage of writing a desired pattern on the surface of a wafer W without using a mask M, by changing the combination of openings to pass an electron beam.

However, if the acceleration of an electron beam applied to the wafer W is too fast, an electron arrived at the lower base of the wafer W reflects upward, and an unexpected area may be written (this phenomenon is called a proximity effect). To prevent the proximity effect, the acceleration of an electron beam is set to low. By setting the acceleration of an electron beam to low, the orbit of a beam becomes easy to be bent by the electrostatic field of the deflecting means 21 and 23. A beam can be accurately passed through the openings of aperture stops 22a, 22b, . . . , and applied to a predetermined position on the surface of the wafer W.

However, in electron beam writing exposure, the amount of energy injected from a low acceleration electron beam to a resist is small, and the amount of proton (Ht) generated inside a chemically amplified resist is insufficient. Thus, even if PEB is performed after writing, sufficient proton (H⁺) may not diffuse in a writing area. Acid catalysis is not accelerated, and a resist is not sufficiently reformed. As a result, a pattern is not formed, or a pattern is formed but the accuracy of the pattern line width is decreased.

In the near future, there will be a movement to set a beam acceleration lower to accurately control an orbit of electron beam. A problem of trading off a low beam acceleration and high throughput will be more apparent.

The above problem is not solved merely by increasing the acceleration of an electron beam and applying a high-acceleration high-energy electron beam to a resist. Because, a high-acceleration electron beam passes through a resist without exposing a resist (the effective sensitivity of the resist is low), a proton (H⁺) is insufficiently produced, and acid catalysis is not accelerated. Thus, the time of applying an electron beam to a resist must be set long in the electron beam writing exposure, in order to inject sufficient energy of electron beam to a resist. However, by setting the electron beam application time long, a processing throughput is decreased. For this reason, electron beam writing exposure is practically difficult.

As described above, in electron beam writing exposure, the effective sensitivity of a chemically amplified resist is low and the exposure time is long, and the throughput is extremely lower than exposure by a stepper (reduction projection step and repeat exposure system) using KrF excimer laser (λ=248 nm) or ArF excimer laser (λ=193 nm).

### DISCLOSURE OF INVENTION

It is an object of the invention to provide a substrate processing apparatus and method, which obtain a resist pattern with precise line width by accelerating chemical amplifying reaction as acid catalysis in a resist, in a process of heating a substrate coated with a chemically amplified resist and exposed by a low-acceleration electron beam, for example.

A substrate heating apparatus for heating a substrate coated with a film of chemically amplified resist within a period after exposure and before development, comprising:

a mounting table to mount the substrate substantially horizontal with the resist-coated film faced up;

a fluid supply mechanism to supply the substrate with a resist reforming fluid to accelerate acid catalysis in the chemically amplified resist; and

a heater to heat the substrate on the mounting table, in a state that the resist reforming fluid contacts the resist-coated film.

In the apparatus of the present invention, a fluid supply mechanism is not limited to only one that supplies a resist reforming fluid to a substrate placed on a mounting table, but includes the one that supplies a resist reforming fluid to a substrate before placing on a mounting table.

The apparatus of the invention has a fluid control member, which is provided opposite to a substrate on a mounting table, makes a clearance above the substrate, and holds a resist reforming fluid in the clearance.

The fluid control member may have a fluid supply port as a part of a fluid supply mechanism. In this case, the fluid supply port is formed at the center of the lower surface of the fluid control member. The clearance is set to a size to spread a resist reforming fluid in the clearance by capillary action.

The apparatus of the invention preferably has a cooling liquid supply port, which is formed on the lower surface of the fluid control member and used for supplying a cooling liquid to the surface of a substrate after heating.

The apparatus of the invention preferably has a fluid suction port, which is formed on the lower surface of the fluid control plate and used for absorbing the resist reforming fluid existing in the clearance.

The apparatus of the invention preferably has an up-and-down mechanism, which moves up and down the fluid control member in order to adjust the clearance.

A heater may be provided on a mounting table or fluid control member. If a heater is provided on both mounting table and fluid control member, PEB is performed more efficiently and a throughput is increased.

Exposure is electron beam exposure for writing a pattern on a resist-coated film by using an electron beam. The invention is used for a PEB process after electron beam exposure.

A resist reforming fluid may be a liquid containing glycerin (C₃H₈O₃), or a vapor or mist containing glycerin. The inventors assume that water (H₂O) contained in glycerin acts on a resist component, and accelerates acid catalysis in a resist during PEB. Glycerin is very excellent in hygroscopicity and moisture retention, infiltrates water (H₂O) into a resist, and increases activity of proton (H⁺) in the resist. As a result, acid catalysis in a resist is accelerated. To produce a mist or vapor containing glycerin, pour glycerin into a vaporizer together with a solvent (e.g., water), and spray a mist-like glycerin mixture from the vaporizer.

The apparatus according to claim 1, further comprising a fluid control member which is arranged opposite to the substrate on the mounting table, makes a clearance above the substrate, and holds the resist reforming fluid in the clearance.

In the method of the present invention, a process of supplying a resist reforming fluid to the surface of a substrate may be performed before a process of placing a substrate on a substrate mounting table. Placing a substrate on a substrate mounting table after supplying a resist reforming fluid to the upper surface of a substrate, and placing a substrate simultaneously with supplying a resist reforming fluid are included in the technical range of the present invention.

In a process (b), a fluid control member is arranged opposite to a substrate on the mounting table, a clearance is formed between the fluid control plate and substrate, and the resist reforming fluid can be supplied to the clearance. After a process (c), the resist reforming fluid existing in the clearance can be absorbed by a fluid suction means. While a fluid suction means is absorbing the resist reforming fluid, a fluid control member can be moved to a substrate to reduce the clearance. After a process (c), a substrate can be cooled by supplying a cooling liquid to the substrate after heating.

### BRIEF DESCRIPTION OF DRAWINGS

FIG. 1A is a schematic sectional view showing a chemically amplified resist film exposed by pattern exposure;

FIG. 1B is a schematic sectional view showing a chemically amplified resist film heated by PEB;

FIG. 1C is a schematic sectional view showing a developed chemically amplified resist film;

FIG. 2 is an internal perspective cross section of a conventional baking apparatus;

FIG. 3 is a perspective sectional view showing exposure by an electron beam writing apparatus;

FIG. 4 is a sectional block diagram showing a substrate heating apparatus according to a first embodiment of the invention;

FIG. 5 is an internal perspective plane view of a substrate heating apparatus according to a first embodiment of the invention;

FIG. 6A is a schematic sectional view showing a step of processing a semiconductor wafer by using a substrate heating method of the invention;

FIG. 6B is a schematic sectional view showing a step of processing a semiconductor wafer by using a substrate heating method of the invention;

FIG. 6C is a schematic sectional view showing a step of processing a semiconductor wafer by using a substrate heating method of the invention;

FIG. 7A is a schematic sectional view showing a step of processing a semiconductor wafer by using a substrate heating method of the invention;

FIG. 7B is a schematic sectional view showing a step of processing a semiconductor wafer by using a substrate heating method of the invention;

FIG. 7C is a schematic sectional view showing a step of processing a semiconductor wafer by using a substrate heating method of the invention;

FIG. 8 (a)-(e) is a timing chart showing a substrate heating method according to a first embodiment of the invention;

FIG. 9 is a sectional view of a block showing essential parts of a substrate heating apparatus according to a second embodiment of the invention;

FIG. 10 (a)-(e) is a timing chart showing a substrate heating method according to a second embodiment of the invention;

FIG. 11 is a sectional block diagram showing a substrate heating apparatus according to a third embodiment of the invention;

FIG. 12 is a sectional block diagram showing a substrate heating apparatus according to a fourth embodiment of the invention;

FIG. 13 is a plane view showing a coating-developing apparatus having a substrate heating apparatus of the invention;

FIG. 14 is a perspective view showing a coating-developing apparatus having a substrate heating apparatus of the invention;

FIG. 15 is a SEM photograph showing a resist pattern of an embodiment executed to confirm the effect of the invention; and

FIG. 16 is a SEM photograph showing a resist pattern of an embodiment executed to confirm the effect of the invention.

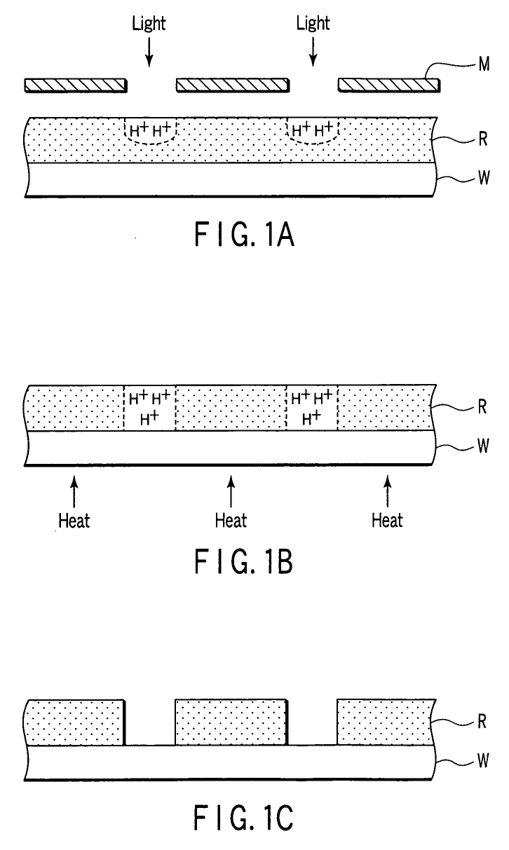

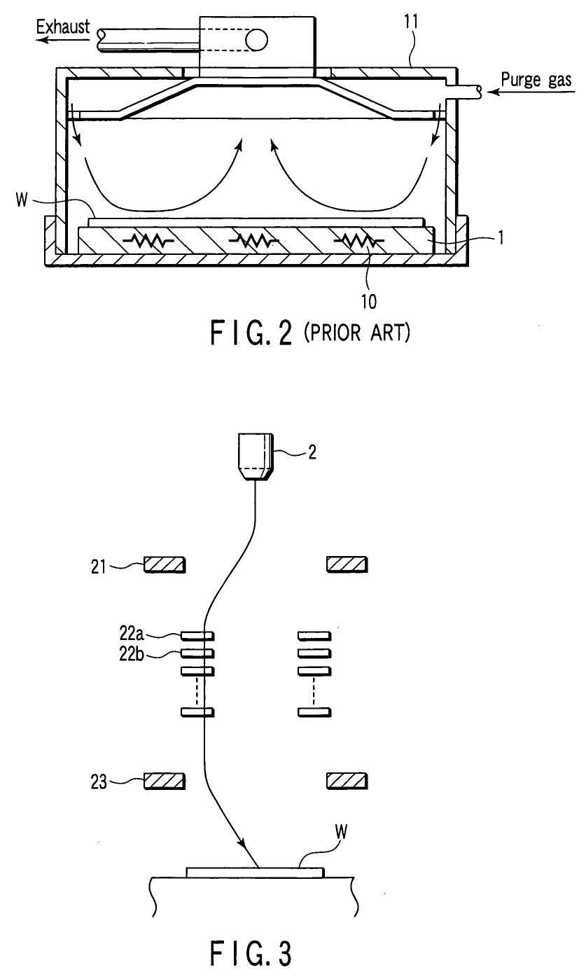

### BEST MODE FOR CARRYING OUT THE INVENTION

Hereinafter, explanation will be given on best mode for embodying the invention with reference to the accompanying drawings.

### Embodiment 1

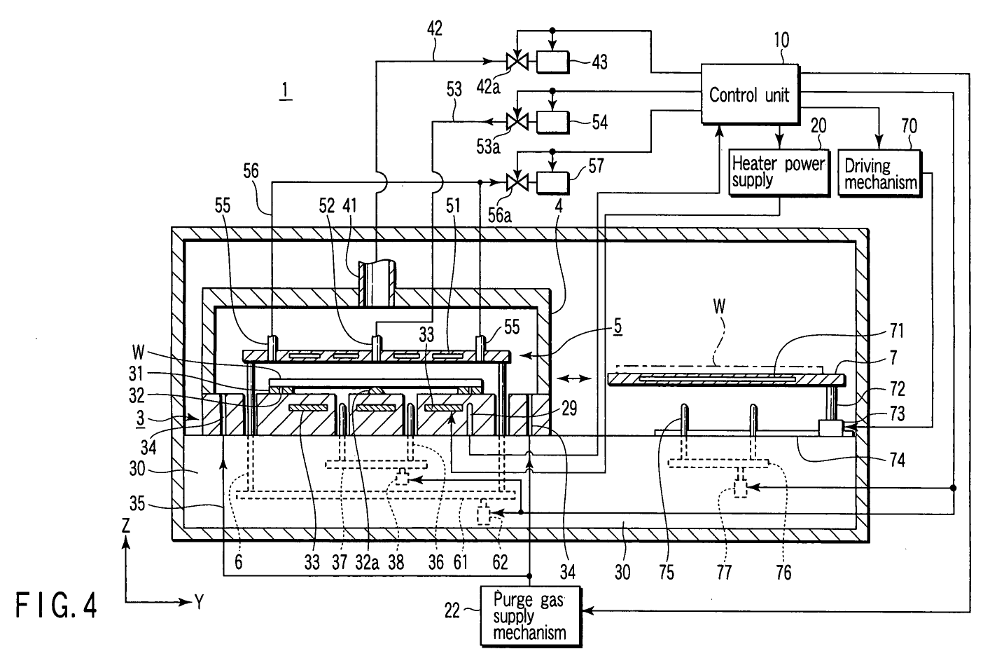

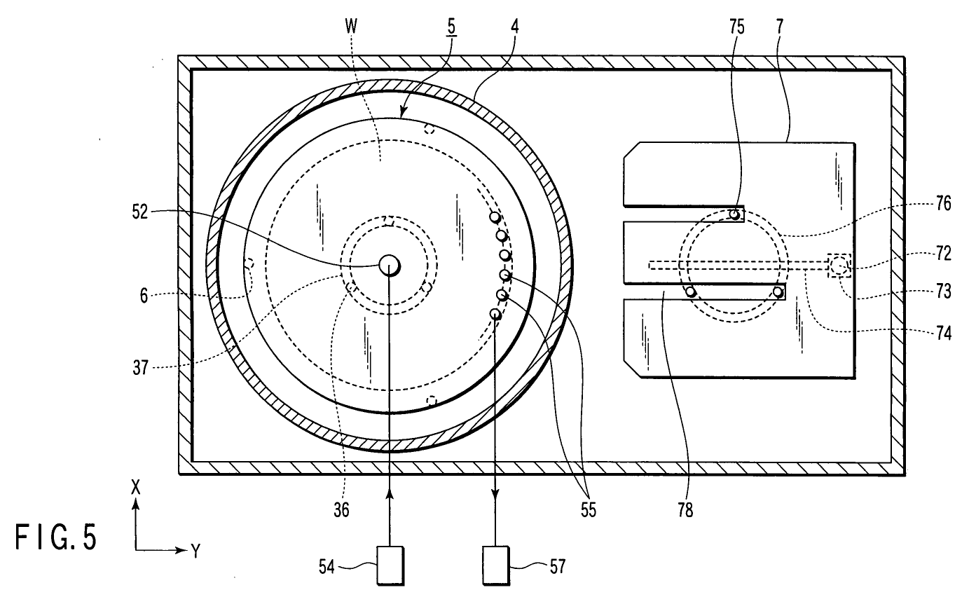

Explanation will be given on a substrate heating apparatus and method according to a first embodiment of the invention with reference to FIG. 4-FIG. 8. In this embodiment, an explanation will be given on an example of a heating-cooling unit formed by combining a cooling unit with a heating unit as a substrate heating apparatus of the invention. But, a cooling unit may be provided independently of a heating unit.

A heating unit and a cooling unit are provided in the housing of the heating-cooling apparatus 1, as shown in FIG. 4 and FIG. 5. The heating unit is placed on the left side in the drawing, and is provided with a mounting table 3 having a heater 33 buried inside, a cover unit 4, and a fluid control plate 5. The cooling unit is placed on the right side in the drawing, and is provided with a cooling plate 7 containing a coolant 71.

The mounting table 3 is provided on a foundation 30, on which a wafer W is placed horizontally. The inside of the foundation 30 is hollow, and provided with support pins 6, 36 and 75, movable bases 37, 61 and 76, and up-down cylinders 38, 62 and 77. The support pin 36, movable base 37 and up-down cylinder 38 constitute a first up-and-down mechanism to raise the wafer W from the mounting table 3. The support pin 6, movable base 61 and up-down cylinder 62 constitute a second up-and-down mechanism to support the fluid control plate 5 movably up and down. The support pin 75, movable base 76 and up-down cylinder 77 constitute a third up-and-down mechanism to raise the wafer W from the cooling plate 7.

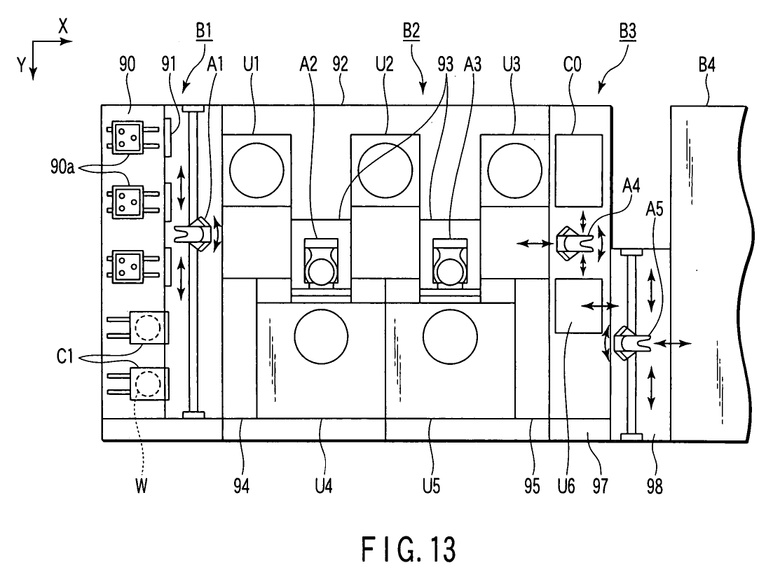

The side of the housing of the apparatus 1 is provided with a substrate carry in/out port (not shown) opened and closed by a shutter. Main carry arm mechanisms A2 and A3 carry the wafer W into or out of the heating-cooling apparatus 1 through the substrate carry in/out port. The upper side of the wafer W carried in the apparatus 1 is coated with a chemically amplified resist (e.g., ESCAP resist or Acetal resist). The resist-coated film is pre-baked in a shell unit U2, and exposed by an electron beam in an exposure block B4 (refer to FIG. 13). The exposure block B4 is provided with an electron beam exposure unit, which emits a low-acceleration electron bam to write a desired pattern on the resist-coated film.

In the invention, the acceleration of an electron beam used for exposure is not limited. A low-acceleration electron beam mentioned in this specification means an electron beam with small amount of injection energy insufficient to write a pattern merely by heating. As an example of acceleration with insufficient injection energy, there is an electron beam of 5 kV or lower.

The heating-cooling apparatus 1 is provided with a control unit 10, a heater power supply 20, a purge gas supply mechanism 22, an exhaust pump 43, a supply source 54, a suction pump 57, up-down cylinders 38/62/77, and a driving mechanism 70. The input section of the control unit 10 receives real time various information from sensors provided at each location in each component of the apparatus 1. Based on these input information, the control unit 10 controls individually the components 20, 22, 43, 54, 57, 38, 62, 77, and 70.

On the top of the mounting table 3, a vacuum ring 31 with a height of 0.1 mm for example is provided. The vacuum ring 31 is provided opposite to the peripheral edge portion of the rear side and all around the wafer W, and absorbs the wafer by vacuum, and prevents the liquid dropped from the upper surface of the wafer W from reaching the rear side. On the top of the mounting table, a projection 31a is also provided to support the central area of the wafer W from the rear side. On the upper surface of the vacuum ring 31, a suction port 32 is formed along the peripheral direction, for example. The suction port 32 is connected to a suction port of a suction pump (not shown) through a not-shown suction pipe.

A plurality of ring heater 33 composed of a resistance heating element is buried in a ceramic main body of the mounting table 3. These ring heaters 33 are concentrically arranged on the mounting table, to heat the whole wafer W as uniformly as possible. The heaters 33 are connected to power supply 20 controlled by the control unit 10.

A temperature sensor 29 is mounted on the ceramic main body of the mounting table 3. A detection end of the temperature sensor 29 is placed in proximity to the upper surface of the mounting table 3. The temperature sensor 29 is connected to the input section of the control unit 10, and sends a temperature (substantially the same as a temperature of the wafer W) detection signal of the mounting table 3 to the control unit 10. Receiving the temperature detection signal from the temperature sensor 29, the control unit 10 obtains the measurement temperature of the mounting table 3 based on the input information, calls a target temperature of PEB from a memory, compares the target temperature (e.g., 105° C. or 140° C.) with the measurement temperature, obtains the difference between them, and sends a control signal to the heater power supply 20 based on the obtained difference value. The power supply operation from the heater power supply 20 to the heater 33 is controlled, and the temperature (substantially the same as the temperature of the wafer W) of the mounting table 3 is approached to a desired target temperature of PEB.

A plurality of air supply port 34 is provided on the side of the mounting table 3 just like surrounding the whole periphery of the mounting table 3. A purge gas supply mechanism 22 is connected to the air supply port 34 through an air supply pipe 35. Fresh air passing through a filter, or inert gas (e.g., nitrogen gas) is supplied as a purge gas.

On the top of the mounting table 3, three support pins 36 to raise and support the wafer W are provided just like projecting to or retreating from the top of the mounting table 3. These support pins 36 are stood up straight on the ring-shaped movable base 37. The movable base 37 is connected to the up-down cylinder 38. The support pin 36 is moved up and down by the up-down cylinder 38 in the state supporting the wafer W horizontal.

The cylindrical cover unit 4 having the upper closed side and lower opened side is provided on the mounting table 3. The cover unit 4 is made of metal (e.g., aluminum). The cover unit 4 is supported movably up and down by a not-shown up-and-down mechanism. The cover unit 4 is retreated to an upper home position when transferring the wafer W from the main carry arm mechanisms A2 and A3 to the mounting table 3, but moved down to form a processing space above the mounting table 3 when PEB is performed.

An exhaust port 41 is formed close to the center of the ceiling of the cover unit 4. The exhaust port 41 is connected to one end of an exhaust pipe 42. The other end of the exhaust pipe 42 is connected to the exhaust pump 43, so that the exhaust pump 43 exhausts air from the processing space.

The fluid control plate 4 is arranged above the mounting table 3, just like opposing to the wafer W. A predetermined clearance is made between the fluid control plate 5 and wafer W. The predetermined clearance is at a height that the resist reforming liquid is spread in the clearance by capillary action, to set the distance to the wafer W to 1-2 mm, for example. The clearance may be set larger according to the viscosity of selected resist reforming liquid. If capillary action is insufficient to spread the liquid, a discharge pressure may be used.

The size of the fluid control plate 5 is equal to or a little larger than an effective area (device forming area) of the wafer W. The fluid control plate 5 is made of ceramic with thickness of 3 mm, for example. The fluid control plate 5 includes a heater 51 burred inside for heating the resist reforming liquid on the wafer W from the upper side. The heater 51 is connected to the heater power supply 20 controlled by the control unit 10.

A fluid supply port 52 is formed at the center of the fluid control plate. The fluid supply port 52 is connected to one end of a flexible piping 53, so that the piping 53 can follow in the up-down stroke range of the fluid control plate 5. The other end of the flexible piping 53 is connected to the resist reforming liquid supply source 54. The piping 53 is provided with a valve 53a and a flow rate regulator (not shown).

When the resist reforming liquid (e.g., glycerin) is supplied from the supply port 52, the liquid spreads from the center to the periphery, and fills the clearance between the wafer and fluid control plate 5. The resist reforming liquid is held in the clearance by surface tension, and not dropped from the mounting table 3.

At least the area of the surface of the fluid control plate 5 opposed to the wafer W is preferably hydrophilic to (easily wet with) the resist reforming liquid. For example, this area of the fluid control plate 5 is surface treated to be easily wet with the resist reforming liquid. This increases the surface tension, and quickly forms a fluid layer with a uniform inside thickness more certainly. Further, it is possible to place the fluid control plate 5 parallel to the wafer W, by providing three or more gap adjustment pins (not shown) on the rear surface of the fluid control plate 5, and touching the ends of these pins to the surface of the mounting table 3.

The resist reforming liquid is a fluid containing a component selected from glycerin and alcohol, for example. It is most preferable to select glycerin as a resist reforming agent in the present invention as described later. In this case, of course the liquid containing glycerin includes liquid formed by glycerin itself (sol). The resist reforming liquid is not limited to the one containing one kind of component selected from the above components. Two or more components may be combined as a resist reforming liquid.

The resist reforming fluid may be a gel or solution including a hydro-gel resin, such as polyacrylic acid chloride, polysulfonic acid salt, quaternary ammonium salt, polyethylene imine, polyvinyl alcohol, polyethylene glycol, polyglutamate, and polyaspartic acid. These hydro-gel resins supply sufficient water (H₂O) to a resist-coated film during PEB, and accelerate acid catalysis in a resist.

The resist reforming liquid may be diluted by using a solvent to adjust the density. However, the resist reforming liquid preferably has a boiling point higher than a set value of the wafer W heating temperature. The resist reforming liquid is preferably supplied after being adjusted in temperature to have no or small difference from the wafer W processing temperature. In this case, the resist reforming liquid temperature may be adjusted by a temperature adjustor provided outside the apparatus, or the resist reforming liquid is heated by the heater 51 up to the wafer W processing temperature by previously forming a resist reforming liquid path (not shown) in the fluid control plate 5, and flowing the resist reforming liquid in this not-shown path.

As shown in FIG. 4 and FIG. 5, a plurality of fluid suction port 55 is formed in the peripheral edge area of the lower surface of the fluid control plate 5. These fluid suction ports 55 are concentrically arranged with predetermined pitches, and connected to the suction port of the suction pump 57 through a flexible pipe 56. These fluid suction ports 55 are connected inside the fluid control plate 5, though omitted in the drawing. The flexible pipe 56 is provided with a valve 56a and a flow rate adjustor (not shown). The supply piping 53 and suction pipe 56 may be connected to the supply source 54 and suction pump 57 outside the apparatus, penetrating through the ceiling of the cover unit 4, or by using the opening of the exhaust port 41.

The fluid control plate 5 is supported in the peripheral edge area by three support pins 6 movable up and down. These three support pins 6 are stood up straight on the movable base 61 provided in the hollow foundation 30, like a ring when viewed from the top. The movable base 61 is movably supported by the up-down cylinder 62. The up-down cylinder 62 is controlled in motion by the control unit 10, and adjusts the clearance between the fluid control member 5 and wafer W.

Next, an explanation will be given on a cooling unit for cooling the wafer W after being heated by the heating unit.

A reference numeral 7 in FIG. 4 and FIG. 5 denotes a plate movable to and from the heating unit in the state holding the wafer W horizontally on its upper surface. The plate 7 includes a path 71 formed inside to flow cooling water. Namely, the plate 7 has both functions as a moving plate to move the wafer W between the heating and cooling units, and a cooling plate to roughly cool (reduce a heat) the wafer W. The cooling plate 7 is supported by a supporter 72. The supporter 72 is connected to a moving base 73. The moving base 73 is held on a guide rail 74 extending in the Y direction toward the mounting table 3. The moving base 73 is driven by a driving mechanism 70, and slides the cooling plate 7 as one body along the guide rail 74.

Under the cooling plate 7, three support pins 75 for supporting the wafer W are provided so as to project and retreat from the upper surface of the foundation 30. These three support pins 75 are mounted on the ring-shaped movable base 76, and the movable base 76 is supported movably up and down by the up-down cylinder 77.

As shown in FIG. 5, the cooling plate 7 has two parallel slits 78. The substrate support pin 75 projects upward the cooling plate 7 passing along the slit 78, and raise the wafer W from the cooling plate 7.

The apparatus has a control unit 10. The control unit 10 controls operations of a suction pump (not shown) connected to the suction port 32, heater power supply 20, up-down cylinder 38, exhaust pump 43, up-down cylinder 62, open/close valves 53a and 56a, and driving mechanism 73.

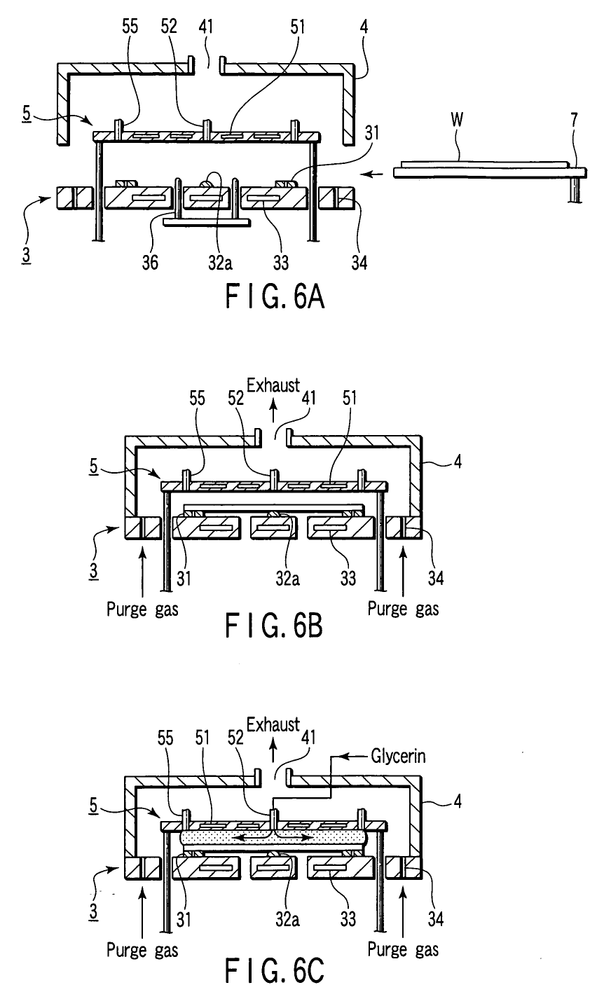

Next, an explanation will be given on the PEB process by using the above-mentioned substrate heating apparatus with reference to FIGS. 6A-6C, FIGS. 7A-7C, and FIG. 8.

After a chemically amplified resist is coated on one side, and a predetermined pattern is written on a resist-coated film by a low-acceleration electron beam, the wafer W is carried into the apparatus 1 at timing t1. When the wafer W is placed above the cooling plate 7 at a retreated position, the support pin 75 moves up, and shifts the wafer E onto the cooling plate 7 by cooperating with the main carry arm mechanism A2. In this time, flow a coolant in the path 71, and cools the cooling plate 7 to a predetermined temperature. Then, the wafer W can be transferred to the mounting table while keeping at a uniform temperature. Retreat the arm of the main carry arm mechanism A2 from the apparatus 1, and close the shutter.

As shown in FIG. 6A, while moving the cover unit 4 and fluid control plate 5 independently to each other, and move the cooling plate 7 forward. The wafer W is carried above the mounting table 3, the substrate support pin 36 moves up and supports the wafer W by pushing up from the rear side, and the cooling plate 7 retreats.

The support pin 36 moves down while supporting the wafer W, and place the wafer W on the mounting table 3. Then, the suction port 32 is set to a negative pressure, and absorbs the wafer W. In this time, the mounting table 3 and support pins 6/36 are preferably set to a temperature not to accelerate acid catalysis in the resist to make the time of acid catalysis same for each wafer W. Concretely, the temperature is preferably lower than 90° C., for example, a temperature close to a wafer heating temperature (e.g. 50° C.) at which acid catalysis is certainly not accelerated, or a room temperature (e.g. 25° C.) without heating. The temperature is not necessarily a value not to accelerate acid catalysis. The outputs of the heaters 33 and 51 may be set to the amounts corresponding to the predetermined temperature to accelerate acid catalysis.

As shown in FIG. 6B, moves down the fluid control plate 5 to set a clearance between the fluid control plate 5 and wafer W to a predetermined clearance, and moves down the cover unit 4 to form a processing space surrounding the periphery of the wafer W. Start exhausting air from the apparatus 1 at timing t2, and start supplying a nitrogen purge gas from the purge gas supply mechanism 22 to the apparatus 1. Namely, by supplying a purge gas (e.g., a fresh air passing through a filter, or a nitrogen gas) from the air supply port 34 to the processing space, and exhausting a purge gas by the exhaust pump 43 through the exhaust port 41, a current of purge gas from the outside to the center is formed in the processing space. It is permitted to stop supplying a purge gas at timing t3, and exhaust air only from the apparatus 1. It is also permitted to turn on the power supply switch at timing t4 and start supplying power to the heater 33, and previously heat the wafer to a predetermined temperature.

Then, open the valve 53a at timing t5, and supply glycerin to the clearance between the wafer W and plate 5, as shown in FIG. 6C. When a predetermined amount of glycerin is supplied with substantially zero discharge pressure, for example, the glycerin spreads in the clearance between the wafer W and plate 5. When the glycerin spreads to the peripheral edge of the wafer W by capillary action, the surface tension and gravity are balanced, and the diffusion shift is stopped. Therefore, a glycerin film with a thickness corresponding to the clearance between the wafer W and plate 5 is formed.

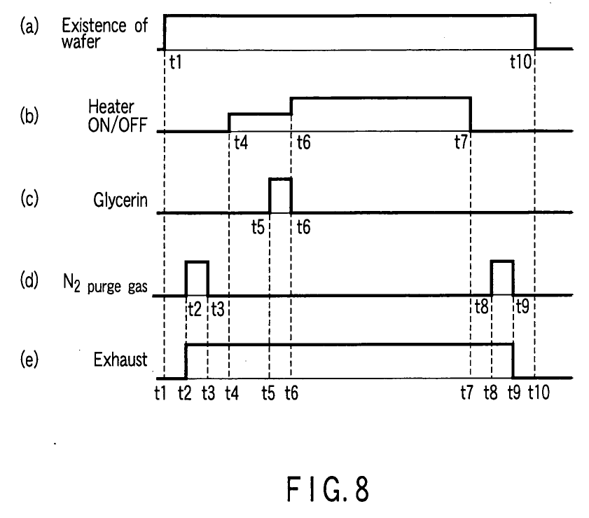

At timing t6, stop supplying the glycerin, increase the amount of power supplied to the heater 33, supply power to the heater 51, and increase a temperature of PEB (refer to (b) and (c) of FIG. 8). Namely, heat the wafer W to a predetermined temperature (e.g., 90-140° C.) by the heaters 33 and 51, and hold the wafer W heated by PEB for predetermined time (e.g., t6−t7=90 seconds) in the state that the glycerin film contacts the resist-coated film. In this time, by heating the wafer W in the state the glycerin film contacts the surface of the resist film, a proton (H⁺) in the resist becomes active and diffuses sufficiently in an exposure area, and accelerates acid catalysis. A written portion becomes soluble in a developing solution when the resist is positive, and indissoluble when the resist is negative.

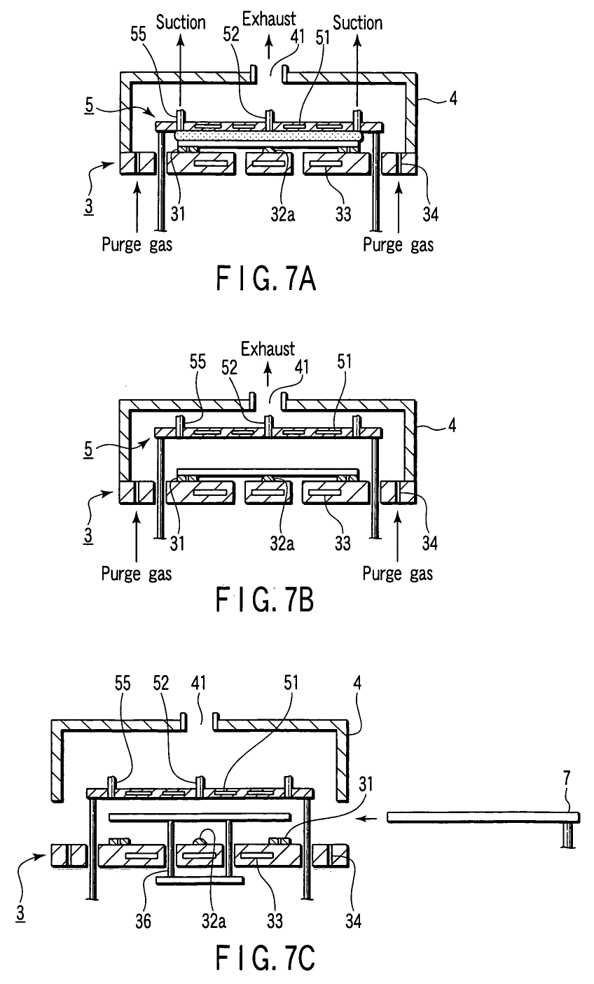

At timing t7, turn off the power supply switch to stop supplying power to the heaters 33 and 51, and finish the PEB process. Then, move down the fluid control plate 5 at a low speed, move the fluid control plate 5 close to the wafer W as shown in FIG. 7A, and set the clearance between the wafer W and plate 5 to 0.1 mm, for example. Open the valve 56a, and drive the suction pump 57 to set the fluid suction port 55 to a negative pressure. Then, the glycerin is removed by suction from the clearance between the wafer W and plate 5.

Then, stop the suction pump 57, and moves the fluid control plate 5 up to the home position as shown in FIG. 7B. The glycerin remained on the upper surface of the wafer W is evaporated and exhausted to the outside of the apparatus 1 together with the purge gas. In the suction process, by moving the fluid control plate close to the wafer W and making the clearance between the wafer W and plate 5 minimum, the glycerin is rarely remained on the surface of the wafer W, and the time required to dry the wafer W is very short. At timing t8, starts supplying the purge gas, and dry the wafer W. At timing t9, stop exhausting air from the apparatus 1, and stop supplying the purge gas ((d) in FIG. 8).

Thereafter, as shown in FIG. 7C, raise the cover unit 4 to a retreated position, and lift the wafer W from the mounting table 3 by the pin 36. Then, move the cooling plate 7 forward, move down the pin 36, transfer the wafer W onto the cooling plate 7, and cool the wafer W on the cooling plate 7. Acceleration of acid catalysis can be stopped by setting the plate 7 to an appropriate temperature. Therefore, the wafer W is transferred to the main carry arm mechanism A2 or A3, and carried out of the apparatus 1 at timing t10. In this embodiment, one cycle t1-t10 of the FEB process is 180-200 seconds.

According to this embodiment, the wafer is heated by PEB in the state that glycerin contacts a resist-coated film, and acid catalysis can be accelerated in a writing area. Therefore, even if radiation energy is insufficient in electron beam exposure and a proton (H⁺) in a resist is insufficient, acid catalysis can be accelerated by increasing the number of protons (H⁺) in a writing area. As a result, as obvious from the results of an embodiment described later, a resist pattern with a highly accurate line width can be formed after development.

In the conventional electron beam exposure, it is necessary to apply an electron beam to a resist for a long time in order to give a resist sufficient energy of electron beam, and a throughput is very low, for example, 0.2 wafer/hour. Contrarily, in the present invention, the time to radiate an electron beam can be reduced without lowering the line width accuracy in electron beam exposure, and a throughput can be largely increased.

As for the reason why acid catalysis is accelerated by heating in the state glycerin contacts a resist film, the inventor considers as follows. When PEB is performed in the state that glycerin contacts a resist film, the water (H₂O) contained in glycerin penetrates into a writing area and makes the writing area hydrophilic. Thus, acid becomes easy to move in the writing area, and diffuses sufficiently in the writing area even if the amount of proton (H⁺) generated during writing is small. However, as penetration of water (H₂O) is accelerated during heating, it is necessary that glycerin contacts the surface of a resist film while the wafer W is being heated by PEB, particularly while acid catalysis is vigorous. To prove the above, the inventor confirmed by experiment that a pattern was not formed when glycerin is supplied to the surface of a resist film, and PEB is performed after removing glycerin.

Further, according to this embodiment, by supplying glycerin to a clearance between the wafer W and fluid control plate 5, a glycerin film with a uniform inside thickness can be formed on the surface of the wafer W. Therefore, even if there is a temperature difference between the wafer W and resist reforming liquid, the amount of heat absorbed by glycerin can be made uniform on the surface of the wafer, and penetration of glycerin and acid catalysis can be uniformly accelerated on the surface. As a result, a resist pattern with a line width with high uniformity in a plane of the wafer can be formed.

Further, according to this embodiment, by spreading liquid between the wafer W and fluid control plate 5 by capillary action, and holding the liquid at the peripheral edge of the wafer W by surface tension, it is prevented that the liquid is dropped from the surface of the wafer W and the apparatus is flooded.

Further, by setting a clearance between the wafer and plate narrow, the amount of glycerin used in one process can be decreased, and the operation cost can be reduced. Glycerin may not be heated in a quiet state, and may be heated by FEB in a state that a current of liquid is formed in the clearance between the wafer W and plate 5 by continuing supply and suction of liquid.

The wafer may be dried by blowing gas to the surface of the wafer heated by PEB through the fluid supply port 52, or by providing a gas blowing means on the surface of the wafer W through a supply port formed in the fluid control plate 5.

Glycerin may not be supplied to the wafer W placed on the mounting table 3. The wafer W may be placed on the mounting table 3 after forming a film of resist reforming liquid by opposing the fluid control plate 5 to the surface of the wafer W supported by the substrate support pin 36, before the wafer W is placed on the mounting table 3.

The glycerin may also be spread on the surface of the wafer W, by separately providing a unit having a solution supply means for supplying glycerin, carrying in the wafer W filled with glycerin on the surface and placing on the mounting table 3, and opposing the fluid control plate 5 to the wafer W.

### Embodiment 2

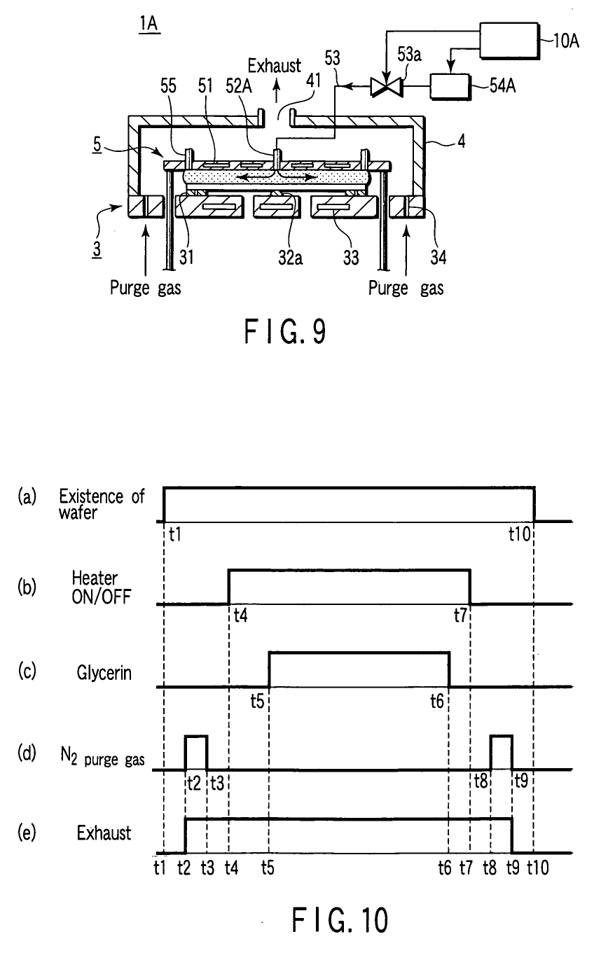

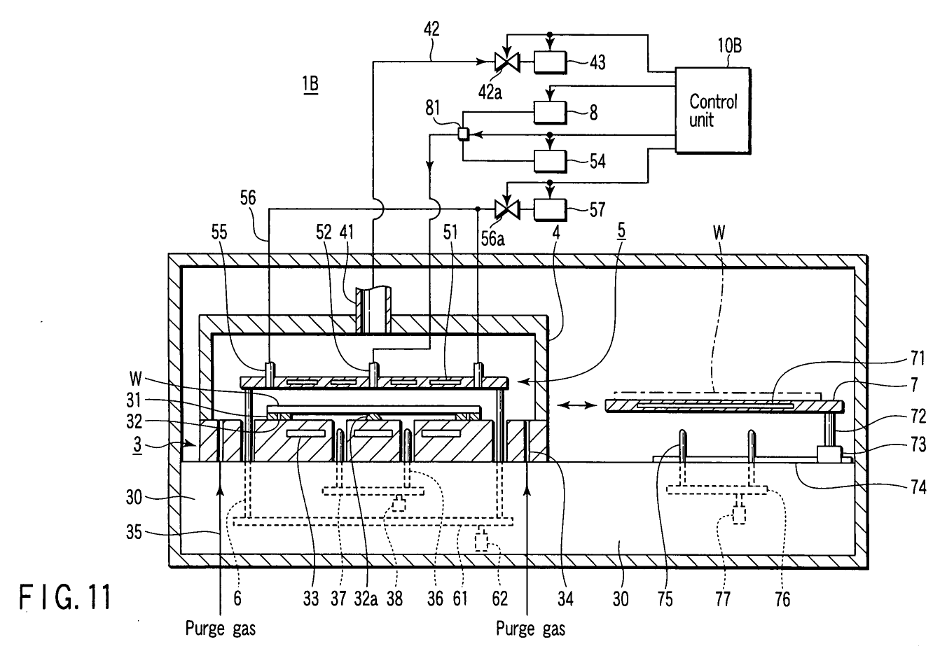

A second embodiment will be explained with reference to FIG. 9 and FIG. 10. Explanation on the same components as those explained in the first embodiment will be omitted.

A unit 1A according to a second embodiment is provided with a fluid supply unit 54A to supply a glycerin-contained mist or vapor to a clearance between the wafer W and fluid control plate 5. The fluid supply unit 54A contains a first tank to contain glycerin, a second tank to contain a solvent, a mass flow controller (MFC), a mixer, and a vaporizer. The vaporizer has a spray nozzle to mechanically or physically spray a mixture of glycerin and solvent as a fine liquid drop. As a solvent, one of alcohol and organic solvent can be used.

An internal flow path of the fluid supply unit 54A is connected to the supply port 52A of the fluid control plate 5 through the flexible piping 53. The flexible pipe is provided with a valve 53a. The control unit 10A controls the fluid supply unit 54A, valve 53a, heaters 33 and 51, and other elements based on a predetermined processing recipe.

Next, an explanation will be given on a process of heating the wafer W by PEB by using the substrate heating unit 1A of this embodiment with reference to FIG. 10.

At timing t1, carry the wafer W into the unit 1A. At timing t2, start exhausting air from the unit 1A, and start supplying a purge gas to the unit 1A. At timing t3, stop supplying a purge gas.

At timing t4, turn on the power supply switch, and starts supply power to the heaters 33 and 51. It is preferable to preheat the wafer W and fluid control plate 4, before supplying a glycerin-contained mist (including a vapor) to a clearance between the wafer W and plate 5. This prevents condensation on the surfaces of the wafer W and plate 5.

An explanation will be given on supplying a glycerin-contained mist to the clearance. At timing t5, starts supplying a glycerin-contained mist. Namely, the control unit 10A drives MFC of the fluid supply unit 54A, leads a predetermined amount of glycerin and solvent from the first and second tanks to the mixer, leads a mixture of glycerin and solvent from the mixer to the vaporizer, and sprays a mist-like glycerin content as a fine liquid drop (containing a vapor). When the control unit 10A opens the valve 53a, the glycerin contained mist flows into the clearance from the supply port 52A through the piping 53, spreads from the center of the clearance to the periphery as shown in FIG. 9, and a part of the spread mist remains in the clearance, and the other is exhausted to the outside of the unit 1A together with exhausted air. At timing t6, stop supplying the glycerin contained mist.

At timing t7, turn off the power supply switch, and stop supplying power to the heaters 33 and 51. Moves the fluid control plate up to the retreated position. At timing t8, start supplying a purge gas. At timing t9, stop exhausting air from the unit 1, and stop supplying a purge gas. At timing t10, carry out the wafer W from the unit 1A.

In this embodiment, the preheating time t4-t5 is approximately 10 seconds, and the glycerin contained mist supplying time t5-t6 is approximately 90 seconds. One cycle t1-t10 of the FEB process is 120-130 seconds in this embodiment.

According to this embodiment, a process of removing a resist reforming liquid from the upper surface of the waver W can be omitted as in case of liquid, and the processing time is reduced and the throughput is increased.

### Embodiment 3

A substrate heating apparatus according to a third embodiment will be explained with reference to FIG. 11. Explanation on the same components as those explained in the embodiments described hereinbefore will be omitted.

A substrate heating apparatus 1B of this embodiment is substantially the same as the apparatus 1 of the first embodiment except having a means for supplying the wafer W with a cooling liquid compatible with a rinse liquid as a cleaning liquid for cleaning the wafer W. In the apparatus 1B, the supply piping 53 connected to the fluid supply port 52 is branched halfway and connected to a supply source 8 of a cooling liquid, for example, pure water adjusted in temperature, so that one of the resist reforming fluid and cooling water is supplied to the upper surface of the wafer W through the fluid supply port 52 by a three-way valve 81 operated by a control unit 10B.

A brief explanation will be given on a process of heating the wafer W by FEB by using the apparatus 1B. Supply a resist reforming liquid to a clearance between the wafer and plate 5. Heat the wafer W in the state that the resist reforming liquid contacts a resist film (refer to FIG. 7A). Supply a cooling liquid (a rinse liquid) adjusted to 23° C. for example to the clearance through the supply port 52 by switching the three-way valve 81, and remove the resist reforming liquid by suction through the fluid suction port 55. The resist film surface on the wafer W is cleaned, and the wafer W is cooled. Acid catalysis is stopped. Thereafter, stop supplying the cooling liquid. Move down the fluid control plate 5, and absorb the cooling liquid through the fluid suction port 55 (refer to FIG. 7A).

Further, according to the example described above, the wafer W can be cleaned more certainly by rinsing in the cooling liquid (rinse liquid). Namely, this embodiment is effective in cases where a component included in a selected resist reforming fluid remains and may affect subsequent process.

It is advantageous to use a cooling liquid with volatility higher (a boiling point lower) than a resist reforming liquid. The time to dry and remove the liquid from the wafer W is reduced. Acid catalysis can be stopped by cooling the wafer W at appropriate timing. Therefore, it is also possible to omit the cooling plate 7 by selecting a temperature of the cooling liquid.

The cooling liquid may not be supplied to the wafer W placed on the mounting table 3, and may be supplied by setting the wafer W at a position separated from the mounting table (heating plate) 3 by the substrate support pin 36, for example. A unit having a cooling liquid supplying means may be provided separately from the apparatus 1B.

### Embodiment 4

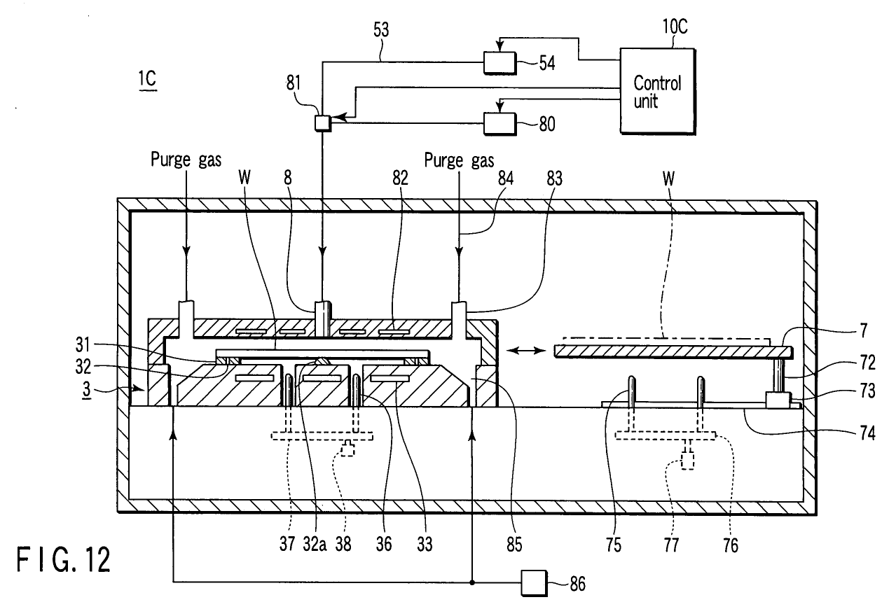

A substrate heating apparatus according to a fourth embodiment will be explained with reference to FIG. 12. Explanation on the same components as those explained in the embodiments described hereinbefore will be omitted.

A substrate heating apparatus 1C of this embodiment is substantially the same as the apparatus 1 of the first embodiment except not having a fluid control plate 5 movable up and down. A cover unit 4 is set to form a predetermined clearance (e.g., 1-2 mm) between the lower surface of its ceiling and the upper surface of a wafer W, when moved down to a descent position. A fluid supply port 8 for supplying a resist reforming liquid (e.g., glycerin) to the wafer W is provided in the area close to the center of the ceiling of the cover unit 4. The fluid supply port 8 is connected to the resist reforming liquid supply source 54 through the supply path 53. Namely, the surface of the ceiling of the cover unit 4 is formed as a fluid control part. A resist reforming liquid is supplied to a clearance between the surface of the wafer W and the surface of the ceiling of the cover unit 4, and a liquid film is formed. The supply path 53 is branched halfway, and one end of the branch is connected to a drying air supply source 80, for example. A reference numeral 81 in the drawing denotes a three-way valve operated by the control unit 10C. By switching the three-way valve 81, one of the resist reforming liquid and drying air can be supplied to the wafer W. A reference numeral 82 denotes a resistance heating heater.

In the area of the ceiling of the cover unit 4 corresponding to the outside of the outer periphery of the wafer W, a plurality of air supply port 83 is provided along the peripheral direction. The air supply port 83 is connected to an air supply pipe 84 for supplying a purge gas, for example, inert gas such as air passing through a filter and nitrogen gas.

In the outside of the wafer W mounting area of the mounting table 3, a plurality of exhaust port 85 for exhausting a resist reforming liquid and purge gas is formed along the peripheral direction. The exhaust port 85 is connected to a suction means 86, for example, an ejector. A shoulder portion of the periphery of the mounting table 3 is inclined downward toward the exhaust port 85 to swiftly flow down the liquid. The inclined shoulder portion of the mounting table 3 is surface treated to have water repellency to a resist reforming liquid. The purge gas may not be supplied from the ceiling side and exhausted from the bottom side. An exhaust port may be formed in the cover unit 4, and a supply port may be formed in the mounting table 3.

When the wafer W is placed on the mounting table 3, the cover unit 4 is closed to form a processing space, and a resist reforming liquid is supplied to a clearance between the wafer W and cover unit 4 through the fluid supply port 8. Then, the wafer W is heated by PEB in the state that the resist reforming liquid contacts the surface of a resist film. Thereafter, switch the three-way valve 81, blow a drying air to the surface of the wafer W to blow off the resist reforming liquid to the outside, and remove the resist reforming liquid from the wafer W. The resist reforming liquid dropped from the wafer W is exhausted through the exhaust port 85. The same effect can be obtained in this configuration.

It is permitted in this example to provide a cooling liquid supply means and to supply a cooling liquid to the surface of the wafer W before supplying air. In this example, the fluid supply port 8 may not be provided at a position corresponding to the center of the wafer W, and may be arranged with intervals in the peripheral direction of the wafer W, for example. The drying air supply means may not be provided. The wafer W may be dried by vaporizing a resist reforming liquid by heating.

Further, in the present invention, to prevent a drop of a resist reforming liquid from the outer periphery of the wafer W when the resist reforming liquid is supplied to the surface of the wafer W, it is permitted to apply a resist to the surface of the wafer W and then make the peripheral edge of the wafer W water-repellent by using the resist applying unit. Concretely, dry the wafer W by coating a water repellent, for example, a fluorine liquid all around the periphery of the wafer W. The same effect as the above can also be obtained in this case. To prevent a drop of the liquid more certainly, it is allowed to previously make a part of the surface of the fluid control plate 5 corresponding to the peripheral edge of the wafer W water-repellent. A drop of the liquid can also be prevented by providing a ring member having a water-repellent surface opposite to the periphery of the wafer W placed on the mounting table 3 through a very small clearance.

Further, in the invention, the wafer W to be heated is not limited to the one written by a low-acceleration electron beam. A wafer written by a high-acceleration electron beam, or a wafer exposed by an exposure unit through a mask is applicable. Acid catalysis can be accelerated also in this case, and a throughput can be increased by heating after exposure in a short time. The invention is also applicable to a process of heating a substrate other than a semiconductor wafer, for example, a LCD substrate and a reticle substrate for a photo mask.

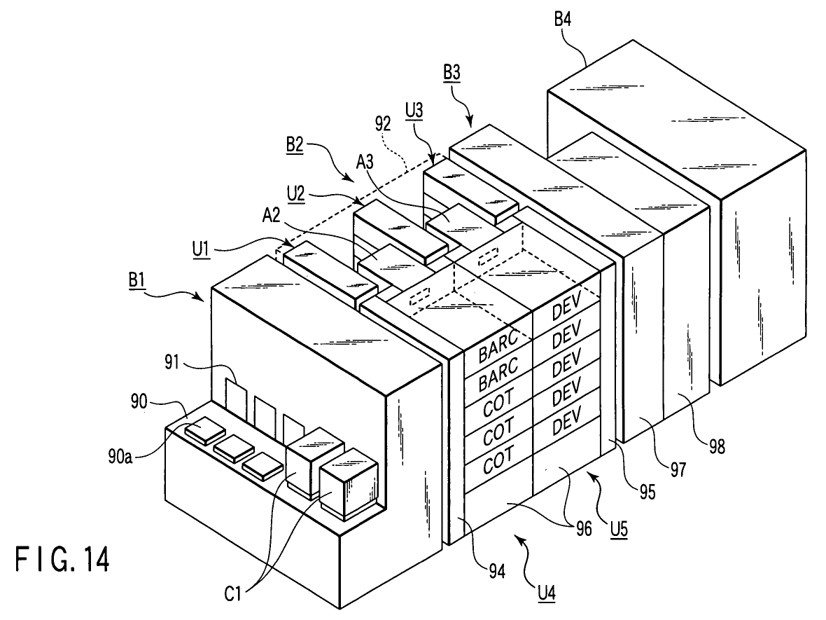

Next, an explanation will be given on a coating-developing apparatus incorporating a substrate heating apparatus of the invention with reference to FIG. 13 and FIG. 14.

A reference numeral B1 in the drawing denotes a carrier mounting block for carrying in and out a carrier C containing 13 wafers W, for example. The carrier mounting block B1 is provided with a carrier station 90 having a mounting table 90a capable of placing a plurality of carrier C, an open/close part 91, and a transfer means A1 for taking out the wafer W from the carrier C through the open/close part 91.

The carrier mounting block B1 is connected to a processing block B2 surrounded by a housing 92. The processing block B2 is provided with shelf units U1, U2 and U3 constructed as multi-staged heating-cooling units, and main carry means A2 and A3 for transferring the wafer W between the processing units including a coating-developing apparatus, arranged alternately and sequentially from the front to rear. These shelf units U1, U2 and U3 and main carry means A2 and A3 are arranged in series, and a not-shown opening is formed in the part connecting them. Through the opening, the wafer W can be freely moved from one end shelf unit U1 to the other end shelf unit U3 within the processing block B1. The main carry means A2 and A3 are arranged in a space surrounded by one side of the shelf units U1, U2, and U3, one side of the liquid processing units U4 and U5, and a partition wall 93 formed by the rear sides of A2 and A3. Reference numerals 94 and 95 in the drawing denote a temperature adjustment unit used in each unit or a temperature-humidity adjustment unit having a duct for adjusting temperature and humidity.

In the liquid processing units U4 and U5, a coating unit COT, a developing unit FEB and an antireflection film forming unit BARC are stacked in 5 stages, for example, as shown in FIG. 14. These liquid processing units are provided on the housing unit 96 containing a tank of chemical solution, such as, a coating liquid (resist) and developing solution. In the shelf units U1, U2 and U3, various heat processing units are stacked in 9 stages, for example. The heat processing units include a post exposure baking unit (PEB) that is a unitary form of the substrate heating apparatus mentioned above, a heating unit for heating (baking) the wafer W, and a cooling unit for cooling the wafer W.

An exposure block B4 is connected to the shelf unit U3 of the processing block B2 through an interface block B3. The interface block B3 includes a first carry chamber 97 and a second carry chamber 98, and has two transfer means A4 and A5 for transferring the wafer W between the processing block B2 and exposure block B4, a shelf unit U6, and a buffer carrier C0.

Next, the flow of wafer W in the coating-developing/exposure system will be briefly explained. When a carrier C is placed on the mounting table 90a of the mounting block B1, a cover is removed from the carrier C, and the wafer W is taken out by the transfer means A1. Then, the wafer W is transferred to the main carry means A2 through a transfer unit (not shown) of the shelf unit U1, and subjected to an antireflection film forming process and a cooling process.

The wafer W is transferred to the coating unit COT, and coated with a predetermined chemically amplified resist. The chemically amplified resist is one of ESCAP resist (e.g., M20G; Product of Japan Synthetic Rubber (JSR), Acetal resist (e.g., UV135; Product of Shipley), or polymethyl methacrylate (PMMA).

After a resist film is formed, the wafer W is heated (baked) by a heating unit that is one of the shelf units U1-U3, cooled, and transferred to the interface block B3 through a transfer unit of the shelf unit U3. In the interface block B3, the wafer W is carried in a route of the transfer means A4—shelf unit U6—transfer means A5. Then, the wafer W is transferred from the interface block B3 to the exposure block B4, and subjected to an exposure process. After being exposed, the wafer is transferred to the main carry means A2 in a reverse route, carried in one of 1A to 1C of the substrate heating apparatus 1 of the invention, and subjected to a PEB process. After being processed by PEB, the wafer W is transferred to the developing unit DEV, and subjected to a developing process. Finally the wafer W is returned to the original carrier C on the mounting table 90a.

Explanations will now be given on an example performed to confirm the effect of the invention, and a comparative example.

### EXAMPLE 1

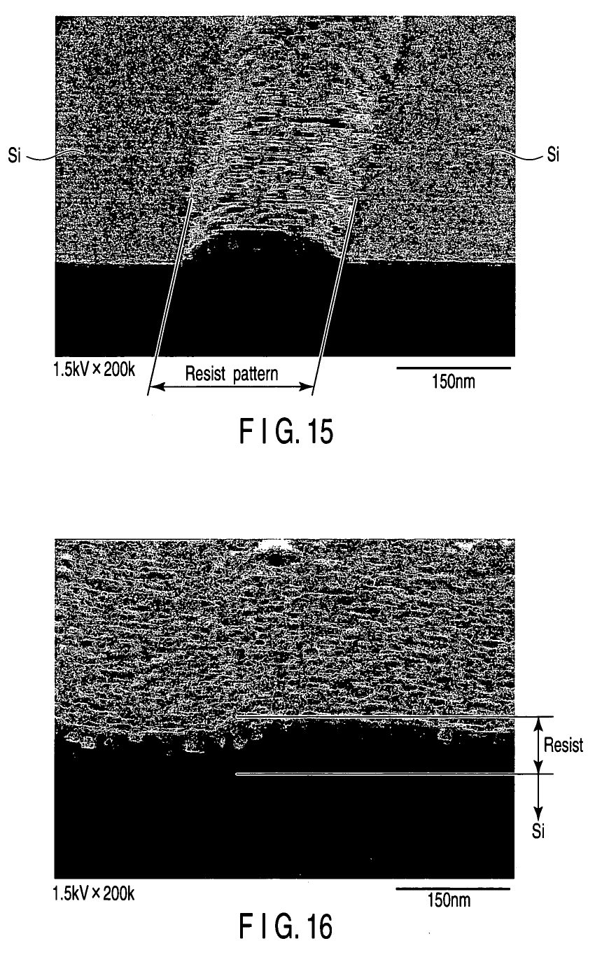

In the example 1, the exposed resist film is heated by PEB with glycerin put on the film surface. The detailed test conditions are given below. After the heating by PEB, the resist reforming fluid is flushed away with pure water, and a pattern s formed by supplying a developing solution to the water surface. FIG. 15 shows the photograph of the formed pattern taken by using a scanning electron microscope (SEM). The chemically amplified resist is M20G (JSR (Japan Synthetic Rubber).

Resist: Positive type ESCAP resist

Resist film thickness: 100 nm

Line width target value: 250 nm

Electron beam radiation amount: 6 mJ/cm²

PEB temperature and time: 90° C., 90 sec.

Pure water supply time: 30 sec.

Developing solution and developing time: TMAH=2.38 weight %, 60 sec.

### COMPARATIVE EXAMPLE 1

The comparative example 1 is performed in the same conditions as the embodiment 1 except that the resist reforming fluid is not used. FIG. 16 shows the photograph of the formed pattern taken by using a scanning electron microscope (SEM).

### RESULTS AND CONSIDERATIONS OF EXAMPLE 1 AND COMPARATIVE EXAMPLE 1

As seen from the results shown in FIG. 15 and FIG. 16, in the example 1 where the resist film is heated by putting glycerin as a resist reforming fluid on the film surface, the written area (electron beam applied area) dissolves in the developing solution, and the resist in the not-written area remains and forms a pattern. The line width of the pattern satisfies the target value. Contrarily, in the comparative example 1 not using glycerin, the resist in the written area remains without dissolving, and a pattern is not formed at all.

According to the above results, it is confirmed that when glycerin is used as a resist reforming fluid, acid catalysis can be accelerated in the PEB process even if an electron beam is set to a low acceleration. Therefore, according to the present invention, a resist pattern with a highly accurate line width can be formed.

1. A substrate heating apparatus for heating a substrate coated with a film of chemically amplified resist within a period after exposure and before development, characterized by comprising:
a mounting table to mount the substrate substantially horizontal with the resist-coated film faced up;
a fluid supply mechanism to supply the substrate with a resist reforming fluid to accelerate acid catalysis in the chemically amplified resist; and
a heater to heat the substrate on the mounting table, in a state that the resist reforming fluid contacts the resist-coated film.

2. The apparatus according to claim 1, further comprising a fluid control member which is arranged opposite to the substrate on the mounting table, makes a clearance above the substrate, and holds the resist reforming fluid in the clearance.

3. The apparatus according to claim 1, wherein the fluid supply mechanism has a supply source of the resist reforming fluid;
a fluid control member which is arranged opposite to the substrate on the mounting table, makes a clearance above the substrate, and holds the resist reforming fluid in the clearance; and
a fluid supply port connected to the supply source and formed on the lower surface of the fluid control member.

4. The apparatus according to claim 2, wherein the fluid supply port is formed at the center of the lower surface of the fluid control member, and the clearance is set to a size to spread the resist reforming fluid in the clearance by capillary action.

5. The apparatus according to claim 2, further comprising a cooling liquid supply port which is formed on the lower surface of the fluid control member, and used to supply a cooling liquid to the surface of a substrate after heating.

6. The apparatus according to claim 2, further comprising a fluid suction port which is formed on the lower surface of the fluid control member, and used to absorb the resist reforming fluid existing in the clearance.

7. The apparatus according to claim 1, wherein the heater is provided on the mounting table.

8. The apparatus according to claim 1, wherein the heater is provided on the fluid control member.

9. The apparatus according to claim 2, further comprising an up-and-down mechanism to move up and down the fluid control member in order to adjust the clearance.

10. The apparatus according to claim 1, wherein the exposure is electron beam exposure for writing a pattern on the resist-coated film by using an electron beam.

11. The apparatus according to claim 1, wherein the fluid supply mechanism supplies liquid containing glycerin, or mist or vapor containing glycerin, as the resist reforming fluid.

12. A substrate heating method of heating a substrate coated with a film of chemically amplified resist within a period after exposure and before development, characterized by comprising:
(a) a step of placing the substrate on a mounting table substantially horizontal with the resist-coated film faced up;
(b) a step of supplying the substrate with a resist reforming fluid to accelerate acid catalysis in the chemically amplified resist; and
(c) a step of heating the substrate on the mounting table, in a state that the resist reforming fluid contacts the resist-coated film.

13. The method according to claim 12, wherein the step (b) includes arranging a fluid control member opposite to the substrate on the mounting table, making a clearance above the substrate, and holding the resist reforming fluid in the clearance.

14. The method according to claim 13, further comprising absorbing the resist reforming fluid existing in the clearance by fluid suction means, after the step (c).

15. The method according to claim 14, wherein while the fluid suction means is absorbing the resist reforming fluid, the fluid control member is moved to the substrate to reduce the clearance.

16. The method according to claim 12, further comprising supplying a cooling liquid to the substrate after heating, and cooling the substrate, after the step (c).

17. The method according to claim 12, wherein the exposure is electron beam exposure for writing a pattern on the resist-coated film by using an electron beam.

18. The method according to claim 12, wherein the resist reforming fluid is liquid containing glycerin, or mist or vapor containing glycerin.
